(19) United States
(12) Patent Application Publication
(10) Pub. No.: US 2026/0078702 A1
(43) Pub. Date: Mar. 19, 2026

(54) DROOP CONTROL HIGH PRESSURE RELIEF VALVE

(71) Applicant: Hamilton Sundstrand Corporation, Charlotte, NC (US)

(72) Inventors: August Coretto, Windsor, CT (US); Matej Rutar, Manchester, CT (US)

(21) Appl. No.: 18/882,044

(22) Filed: Sep. 11, 2024

(51) Int. Cl. F02C 7/232; F02C 9/26

(52) U.S. Cl. CPC F02C 7/232; F02C 9/263; F05D 2220/323; F05D 2240/35

(57) ABSTRACT

A high pressure relief valve comprising a sleeve defining an inlet to the valve, an outlet from the valve and an internal cavity. Further comprising a spool located within the internal cavity, wherein the internal cavity is defined in part by a spool contact surface of the internal cavity that is defined by an inner diameter, wherein the spool contact surface slides against an outer surface of the spool. A valve seat is located about the inlet, wherein the spool has a conical tip configured to contact the valve seat to seal the input to the sleeve. The conical tip ends at a step, wherein a fluid may be directed into the inlet over the conical tip and is turned by the step.

### BACKGROUND

A High Pressure Release Valve (HPRV) for a turbine engine fuel system is a critical safety mechanism designed to regulate and relieve excess pressure within the engine's high-pressure system. Here's a detailed description:

The High Pressure Release Valve is a robust, precision-engineered component typically located at a crucial junction within the turbine engine's high-pressure section. Its primary function is to protect the engine from potential damage caused by over pressurization scenarios, which can arise from various operational conditions such as sudden surges in fuel supply or rapid changes in engine load.

Physically, the valve is constructed from durable materials such as stainless steel or high-strength alloys to withstand the extreme temperatures and pressures encountered within the turbine engine environment. Its design incorporates a spring-loaded mechanism or pneumatic actuation system that allows it to open automatically when pressure levels exceed predetermined value.

In operation, the valve remains normally closed during standard engine performance. However, when the pressure surpasses a set threshold, determined by careful calibration and engineering specifications, the valve swiftly activates. This activation initiates a controlled release of high-pressure fluids or gases, diverting them away from critical engine components and exhaustively venting them into a designated outlet or bypass system. The fluid may be aircraft fuel in one embodiment.

The release process is carefully managed to ensure minimal disruption to engine operation while effectively safeguarding against potential catastrophic failures. Engine systems often incorporate advanced monitoring and feedback systems, enabling real-time data on pressure conditions and valve status to be transmitted to engine control systems for continuous optimization and safety enhancement.

Overall, the High Pressure Release Valve stands as a crucial safeguard within turbine engines, combining robust engineering with precise functionality to uphold operational integrity and protect against the adverse effects of excessive pressure build-up.

### BRIEF DESCRIPTION OF THE DRAWINGS

FIG. 1 shows a schematic view of a fuel system for an aircraft.

FIG. 2 illustrates a Prior Art High Pressure Relief Valve.

FIG. 3 illustrates an improved HPRV.

FIG. 4 illustrates a model of the droop as a result of the improved HPRV.

### DETAILED DESCRIPTION

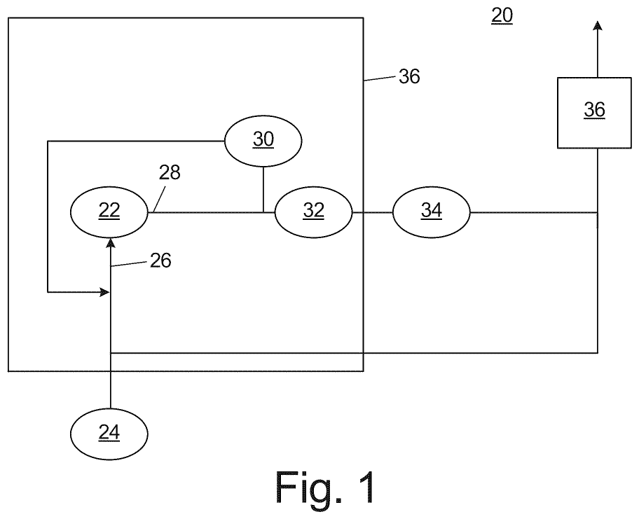

FIG. 1 shows a schematic view of an aircraft fuel supply system 20 having a fuel pump 22 drawing fuel from a fuel supply 24. The pump 22 has a pump inlet 26 in fluid communication with the fuel supply 24 and a pump outlet 28 is in fluid communication with a high pressure relief valve (HPRV) 30. During normal operating conditions the HPRV 30 remains closed and the fuel passes through a filter 32 to remove contaminants. Fuel exiting the filter 32 is then directed to fuel metering system 34 with a fuel metering valve 36 to supply fuel to an engine. If the supply of fuel at the fuel metering system 34 is excessive for the current engine operating condition the excess fuel is ported back to the pump inlet 26.

The HPRV 30 may be positioned immediately downstream of the pump outlet 28. Should the system 20 become clogged or blocked, the pressure will become undesirably high, which could result in damage to the pump 22. The HPRV 30 is configured to automatically open once a specified pressure level is exceeded to allow fuel to return to the pump inlet 26.

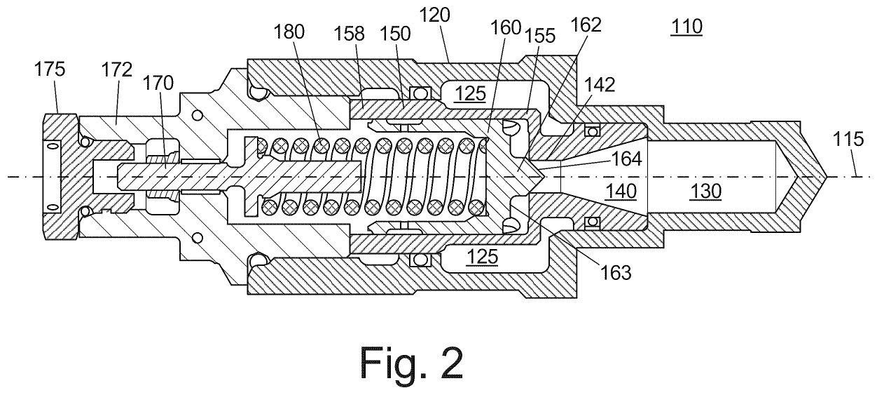

FIG. 2 illustrates a high pressure relief valve (HPRV) 110. The HPRV comprises a housing 120 which includes a passage way 130 into the pump outlet line 28. The passage way, 130 provide a fluid such as fuel at a first pressure Pin, to input 140 of the HPRV 110. A sleeve 150, is inserted into the housing 120, and forms inlet 140 and an inner core to contain spool 160. Spool 160 moves along a longitudinal axis 115 within Sleeve 150. Spring 180 provides a force Sk directly opposing the pressure Pin created by the fluid input to the HPRV 110 from the passage way 130. Spool 160 has a conical tip 162 that seals the inlet 140 at valve seal 142. The conical tip 162 has a face 164 to which the flow from the input 140 is directed. When the pressure Pin, is greater that the spring force Sk, the valve will open allowing fluid to flow through inlet 140 past the conical tip 162 and out an outlet window 155. There may be multiple outlet windows about Sleeve 150. The outlet window 155 allows the fluid to pass through an outlet 125 of the HPRV to the pump inlet 26 or an alternative location. The HPRV 110, may also have an adjusting screw 170 which sets the spring force Sk The adjusting screw 170 may be held in place with closure 172 and adjusting cap 175. To allow for equalization of pressure on either side of the spool, the outlet 125 may provide fluid through relief window 158, to permit fluid to flow behind the spool 150.

Prior art High Pressure Relief Valves (HPRVs) often have difficult to predict and unstable performance characteristics, for example after some valves open, they can immediately go fully open, dropping pressure more than desired. With certain fuel control arrangements (i.e. actuation systems) this characteristic is unworkable in the system and further developments are needed in order to meet future system architectures.

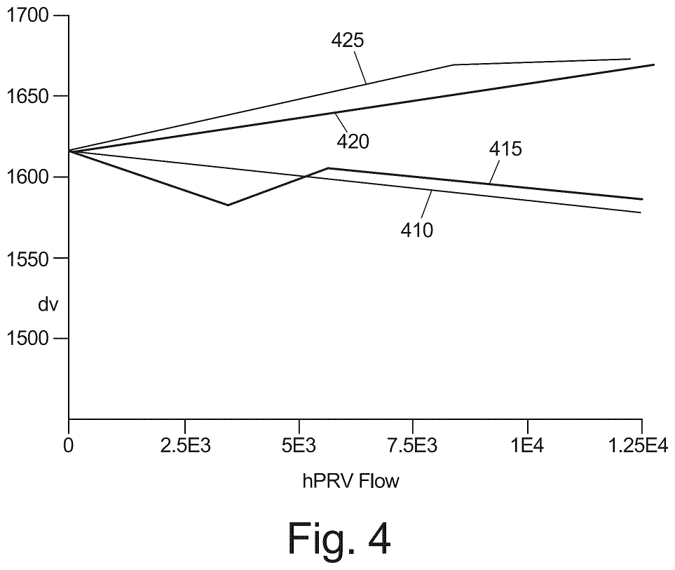

The operation of a prior art HPRV is illustrated in FIG. 4 with curves 410 and 415. FIG. 4 illustrates an example of the interaction of the pressure differential versus the flow through the HPRV. The X axis shows the HPRV flow and the Y axis illustrates the pressure differential (AP) across the valve. AP is similar to the pressure differential at the pump inlet 26 compared to the pump outlet 28 of FIG. 1. Line 410 illustrates one plot of AP versus flow for a prior art HPRV when it opens. As shown, during operation of the prior art HPRV, line 410 indicates that as the flow across the HPRV increases the AP decreases. This may result in droop in the system which may be detrimental to the operation of the system. In a second embodiment of a prior art HPRV the graph line 415 is an inconsistent decreasing regulated pressure as flow increases. The prior-art HPRVs are prone to be inconsistent regulating pressure characteristics as shown. Two additional HPRV performance curves illustrate an example of the performance of an embodiment of the proposed HPRV. The first graph line 420 illustrates a consistently increasing regulating pressure with flow and the second graph line 425 illustrates a consistent increasing regulating pressure with flow with a specified maximum limit. The improved HPRV may create a significantly more consistent analytical valve performance and allow for an increased ability to adjust the curve to meet system requirements.

The effects of the prior-art performance characteristics in a system may be as follows: when the HPRV begins to open, because of the negative slope as shown in lines 415 and 410, the HPRV opens suddenly and uncontrollably, potentially leading to a momentary drop in flow leaving the system as the fuel system cannot respond to an immediate change in flow going toward the HPRV. In addition as the fuel system continues to command more flow, because of the negative characteristics, the additional flow requested may not be achieved and the relationship between commanded flow and received flow is broken. In a pressure-commanded system the relationship is also broken, as in general the relationship is to command additional flow in order to create additional pressure. With a decreasing flow, adding additional flow to the system would decrease system pressure. It has also been determined that a system hysteresis effect may be created as an HPRV with negative droop is difficult to close after it has opened. The system pressure must be reduced to lower than the lowest regulated pressure in order for HPRV to close again.

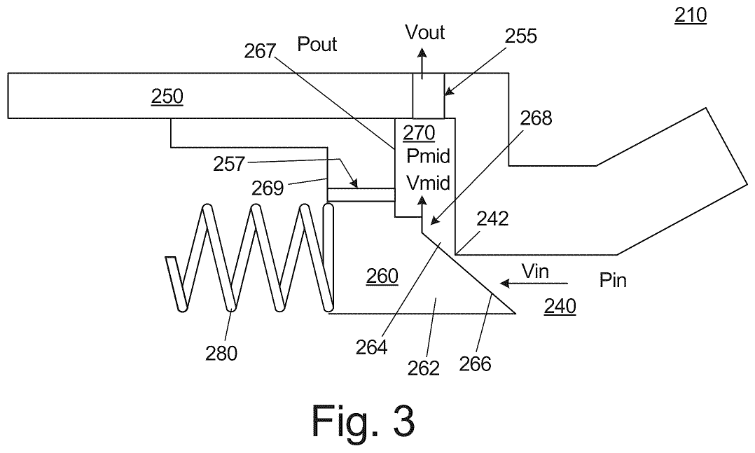

To alleviate the issues that prior art HPRVs may exhibit, a new embodiment is proposed which modifies the HPRV of FIG. 2. FIG. 3 illustrates a modification of FIG. 2, which allows for consistently increasing droop (regulated pressure vs. flow characteristic) such that it may operate in newer variable displacement systems where there is no extra bypass flow. The HPRV includes a new feature of a step 268 on the spool face 267 to consistently turn flow by a preselected angle (e.g., 90 degrees±a desired margin or other desired angle) and allow the momentum effects to be calculated. The improved HPRV also includes pass-through holes 257 in the spool 260 to remove the pop-open effect of the HPRV when the valve windows 155 (See FIG. 1) have significant pressure drop. Finally, the size of the HPRV windows 255 may be chosen to compensate fully for the negative droop from momentum load, so that the droop is constantly increasing.

FIG. 3 illustrates an improved HPRV 210. The improved HPRV may incorporate a sleeve 250 similar to sleeve 150 of FIG. 2 to define an internal cavity. The sleeve defines an input 240 and is sealed at valve seal 242, by conical tip 262 of spool 260. Conical tip 262 has a first nozzle face 266 which is the surface of conical tip 262 in the input 240. Conical tip 262 has a second nozzle face 264 that is in an area of the conical tip 262 that appears downstream of the valve seal 242. Conical tip 262 further incorporates a step 268. The step results in the flow through the HPRV 210 consistently turning by a preselected angle (e.g., 90 degrees±a desired margin or other desired angle), which allows for simple calculations of momentum effects. The step 268 appears down stream from second nozzle face 264. The step 268 is an improvement from prior art HPRV as it forces the flow to follow the same flow structure over the full operating range of valve position and valve flows. Prior conical HPRVs see a change in flow structure as flow rate increases. For example in the prior art conical HPRV as shown in FIG. 2, the flow as it reaches face 163 may cause unstable airflow such as an eddy as it leaves face 164. FIG. 4 as discussed above illustrates a prior art HPRV droop curve with inconsistent performance.

The sleeve 250 further has an outlet window 255 positioned such that the spool does not close the outlet window 255 when the conical tip 262 seals with valve seat 242. As represented in FIG. 3, the spool does not partially occlude the valve window, therefore flow leaves the sleeve at a preselected angle (e.g., 90 degree angle±a desired margin or other desired angle) ensuring no additional momentum effect is generated by window 255, regardless of the position of spool 260 As stated earlier, the outlet window 255 may be multiple windows located about the periphery

Spool 260 further has one or more a pass through holes 257 to permit fluid to flow through the spool 260 from the front face area 267 through to the rear face 269 of the spool 260 in contact with the spring 280. The pressure at the front face area 267 may be defined as Pmid, which occurs in the region from the inlet 240 to the outlet window 255. The pressure at the inlet 240 is Pin, with velocity of flow being Vin, where V is velocity. Pressure at the outlet window 255 is Pout, and the velocity flowing out the outlet window 255 is Vout. The pass through 257 allows for the pressure on either side of the spool 260 to equalize such that Pmid does not create an opening load on the valve.

The pressure across HPRV 210 varies as the fluid travels from the input to the output of the valve. The input pressure Pin, is normally higher then the output pressure and may range from 500 to 5000 psid Pin-Pout during normal operation depending on system. The valve may be set to open when Pin-Pout is at or about 500-5000 psid Pin-Pout as set by the adjusting screw 170. As a result of the Step 268, combined with the pass through holes 257 and outlets 255 results in better droop control. As shown in FIG. 4 in curves 420 and 425 the droop may result in a steady increase in pressure Pin as fluid flow through the HPRV increases

In an other embodiment, the window 255 may be larger and may allow for partial occlusion. The window 255 would be partially occluded when the spool 260 is in the closed position. Tuning of the valve 210 would prevent the negative effects of the prior art HPRV. The partially occluded window 255 may result in additional momentum affects. This would require additional steps for balancing the system and tuning of the window 255.

As a result of implementing a system as shown in the force balance across the HPRV 210 may be calculated as follows:

$$\sum F ( + x ) = Pin * AnozzFace 1 + Pmid * ( AnozzFace 2 + StepFace + MidFace ) + mdot * Vin - kspring * X - Pmid * ArearFace$$

Wherein Pin, is the pressure at the input 240, AnozzFace1 is the area of the face at 266, Pmid is the pressure after valve seal 242, AnozzFace 2 is the area at 264, and the StepFace is the are of the step face 268. The MidFace is the area of the face 267, and the mdot*Vin is the momentum of the spool 260. Kspring*X is the pressure due to the spring and Arear is the area of the rear face of spool 269. The equation results in the measured force balance across the valve. This allows for the tuning of the spring pressure to calibrate the HPRV 210.

The pressure drop across HPRV 210 may be calculated by utilizing the formula, noting that each listed contributing calculation is a separated calculation and each follows relevant industry standards for calculation of pressure drop though various flow discontinuities:

$$Total Pressure Drop = dP ( upstream of valve ) + contraction ( Pupstream to Pin ) + orifice ( Pin to Pmid ) + expansion ( within Pmid ) + orific ( Pmid to Pout ) + dP ( downstream of valve )$$

Orifice dP(Pin to Pmid) refers to an orifice flow calculation per industry standards. The expansion (within Pmid) is referring to the slight pressure change due to flow from the inner diameter of the Pmid cavity to the outer diameter. Orifice (Pmid to Pout) is the same equation as the prior orifice, but is now calculating the pressure drop from Pmid to Pout.

With all the pressure drops calculated, the total pressure drop can be summed, and the pressure equations can be combined with the force balance equation to solve for the regulated pressure and flow.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A high pressure relief valve (HPRV) comprising:
a sleeve having an inlet, an outlet, an internal cavity, and a valve seat;
a spool located within the internal cavity, having a front face and a rear face, the spool comprising:
a conical tip on the front face of the spool, adapted to contact the valve seat to seal the inlet to the sleeve; and
wherein the conical tip has a step, the conical tip configured such that a fluid directed into the inlet over the conical tip when the HPRV is in operation will be turned by the step and directed toward an outlet window.

2. The high pressure relief valve (HPRV) of claim 1 wherein the spool further comprises a pass through hole through the spool from the front face to the rear face.

3. The high pressure relief valve (HPRV) of claim 1, wherein an outlet is configured to allow a fluid to exit the sleeve between the spool front face and the sleeve when the HPRV is in operation.

4. The high pressure relief valve (HPRV) of claim 3, wherein the outlet is positioned such that the outlet is open when the spool is in contact with the valve seat.

5. The high pressure relief valve (HPRV) of claim 3, wherein the outlet is positioned such that the outlet is partially occluded when the spool is in contact with the valve seat.

6. The high pressure relief valve (HPRV) of claim 3 wherein when the high pressure relief valve has a longitudinal axis and wherein the spool is adapted to move along the longitudinal axis.

7. The high pressure relief valve (HPRV) of claim 6, further having a spring located on the rear face of the spool, wherein the spring it configured to exert a force Sk to bias the spool towards the valve seat and to oppose a pressure Pin created by the fluid flowing into the HPRV when the HPRV is in operation.

8. The high pressure relief valve (HPRV) of claim 7, wherein the high pressure relief valve is configured such that when a pressure at the inlet exceeds a predetermined value, the spool moves along the longitudinal axis to allow a fluid to pass over the conical tip to the outlet.

9. The high pressure relief valve (HPRV) of claim 8 wherein a force balance equation for the high pressure relief valve is equal to:
$$\sum F ( + x ) = Pin * AnozzFace 1 + Pmid * ( AnozzFace 2 + StepFace + MidFace ) + mdot * Vin ( momentum ) - kspring * X - Pmid * ArearFace .$$

10. The high pressure relief valve (HPRV) of claim 9 where in a total pressure drop across the high pressure relief valve is equal to:
$$Total pressure drop ( function of Mdot ) = dP ( upstream of valve ) + contraction ( Pupstream to Pin ) + orifice ( Pin to Pmid ) ( function of stroke + X ) + expansion ( within Pmid ) + orifice ( Pmid to Pout ) + dP ( downstream of valve ) .$$

11. A aircraft fuel supply system comprising:
a fuel pump configured to provide fuel from a fuel supply, the pump having a pump inlet in fluid communication with the fuel supply and a pump outlet;
a high pressure relief valve (HPRV) in fluid communication with the pump outlet;
a filter in fluid communication with the pump outlet, wherein the filter is configured to remove contaminant from a fluid passing through the filter to a fuel metering valve when the aircraft fuel supply system is in operation;
wherein the high pressure relief valve is configured to be in a closed position when the pressure at the pump outlet equal to or below a predetermined level, and wherein the high pressure relief valve is configured to be in an open position when the pressure at the pump outlet exceeds said predetermined level when the aircraft fuel supply system is in operation; and
where in the high pressure relief valve comprises:
a sleeve having an valve inlet, a valve outlet, an internal cavity, and a valve seat;
a spool located within the internal cavity, having a front face and a rear face, the spool comprising:
a conical tip on the front face of the spool, adapted to contact the valve seat to seal the input to the sleeve; and
wherein the conical tip has a step, the conical tip configured such that a fluid is directed into the valve inlet over the conical tip when the aircraft fuel supply system is in operation and the fluid is turned by the step and directed toward an outlet window.

12. The aircraft fuel supply system of claim 11 wherein the spool further comprises a rear face, and a pass through hole through the spool from the front face to the rear face.

13. The aircraft fuel supply system of claim 11, wherein the valve outlet is configured to allow a fluid to exit the sleeve between the spool front face and the sleeve when the aircraft fuel supply system is in operation.

14. The aircraft fuel supply system of claim 13, wherein the valve outlet is positioned such that the valve outlet is open when the spool is in contact with the valve seat.

15. The aircraft fuel supply system of claim 13, wherein the valve outlet is positioned such that the valve outlet is partially occluded when the spool is in contact with the valve seat.

16. The aircraft fuel supply system of claim 13 wherein when the high pressure relief valve has a longitudinal axis and wherein the spool is adapted to move along the longitudinal axis.

17. The aircraft fuel supply system of claim 16, further having a spring located on the rear face of the spool, wherein the spring it configured to exert a force Sₖ to bias the spool towards the valve seat and to oppose a pressure Pin created by the fluid flowing into the HPRV when the HPRV is in operation.

18. The aircraft fuel supply system of claim 17, wherein the high pressure relief valve is configured such that when a pressure at the valve inlet exceeds a predetermined value, the spool moves along the longitudinal axis to allow a fluid to pass over the conical tip to the valve outlet.
